(19) United States
(12) Patent Application Publication
(10) Pub. No.: US 2007/0099633 A1
(43) Pub. Date: May 3, 2007

(54) Method, configuration and computer program comprising program code means and computer program product for determination a selected position of a mobile communications device within a communications network

(76) Inventors: Joachim Bamberger, Stockdorf (DE); Kai Peter Briechle, Neu-Ulm (DE); Marian Grigoras, Neubiberg (DE); Uwe Hanebeck, Waldbronn (DE); Clemens Hoffmann, Ottobrunn (DE); Andreas Rauh, Germering (DE)

Correspondence Address: STAAS & HALSEY LLP, SUITE 700, 1201 NEW YORK AVENUE, N.W., WASHINGTON, DC, 20005, US

(21) Appl. No.: 10/554,072

(22) PCT Filed: Mar. 29, 2004
(86) PCT No.: PCT/EP04/03320

§ 371 Date: Oct. 24, 2005

(51) Int. Cl. H04Q 7/20

(52) U.S. Cl. 455/456.2

(57) ABSTRACT

The position of a mobile communications device within a communications network (localization) is determined using communications signals of a base station that communicates with the mobile communications device using a mobile communications network. A possible area of location is determined using a non-linear communication model based on non-linear Bayesian filtering. The selected position of the mobile communications device is then determined on the basis of the possible area of location.

### CROSS REFERENCE TO RELATED APPLICATIONS

This application is based on and hereby claims priority to German Patent Application No. 103 18 590.9 filed on Apr. 24, 2003, the contents of which are hereby incorporated by reference.

### BACKGROUND OF THE INVENTION

1. Field of the Invention

The invention relates to determining a position of a mobile communications device in a communications network (localization).

2. Description of the Related Art

With the increasing spread of mobile communications, the demand for additional services in the mobile radio system is also growing.

Location Based Services in this case are taken to mean additional services of mobile radio operators which are offered or provided to users of the mobile radio system on a location basis, i.e. depending on a position or a geographical location of relevant users, for example location or distance-dependent usage tariffs or orientation aids for search and rescue services.

Fundamental to a “Location Based Service” is therefore the localization or position determination of the user concerned or of their mobile communications device.

Different techniques are known for such localization of mobile communications devices in communications networks, for example determining the position on the basis of delay time determination or delay time measurements of communications signals of a mobile wireless communications device to a base station of a communications network (Rappaport T. S., Reed J. H. et al., “Position Location Using Wireless Communications on Highways of the Future”, IEEE Communication Magazine, pp. 33-41, October 1996, DE 198 36 778 Al) or a localization by a satellite-assisted system such as GPS.

The delay time-based position determination known from DE 198 36 778 Al is executed for a mobile telephone, generally a mobile station, in a GSM communications network (=Global System for Mobile Communications) (Eberspächer, J.; Vögel, H.-J.: GSM. Global System for Mobile Communication. Stuttgart, Leipzig: Teubner, 1999; Jung. P.: Analyse und Entwurf digitaler Mobilfunksysteme. Stuttgart, Leipzig:Teubner, 1997; Kennemann, O.: Lokalisierung von Mobilstationen anhand ihrer Funkmessdaten. Nummer 11 in Aachener Beiträge zur Mobil-und Telekommunikation. Aachen: Verlag der Augustinus Buchhandlung, 1997) in accordance with a TDMA (Time Division Multiple Access) mobile radio technology.

An individual mobile station, which has registered with a fixed local base station (a base station which is controlling the call) is currently assigned a free time slot in a TDMA frame by the base station.

The communications signals intended for the mobile station concerned go to this time slot in signal packets, known as bursts, with a length of 15/26 ms, from the base station or the communications signals or bursts sent from the mobile station must arrive at the base station.

As a result of scattering the communications signals emitted by the base station find their way to the mobile station via different paths (multipath propagation), in which case they are attenuated depending on their frequency.

A receive field strength of the communications signals received by the mobile station is thus not only dependent on the distance from the mobile station to the base station, but also on the frequency and topographical circumstances between mobile station and base station. Therefore the individual data packets are sent on different carrier frequencies, which allows selective interference on one frequency to be distributed between a number of users.

However a precise synchronization between mobile station and base station is needed to enable this to be done. This synchronization is additionally made more difficult by a mobility of the user, since the mobile station is now located at changing distances from the base station and its communications signals exhibit different delay times.

To equalize the different delay times and enable frame-synchronized data to be delivered to the base station, the mobile station measures the signal delay time to the base station and uses this to correct the start of sending its bursts.

The signal delay time is encoded in a “timing advance” (TA) and exhibits a dependency on the distance between mobile station and base station controlling the call.

64 stages are available for the TA which are (bit) encoded with the values 0 to 63 and represent the delay time.

Since positions of base stations are known the position of the mobile station can be concluded from a TA or from the signal delay time.

A measurement accuracy for determining the delay time relates to a bit duration, which is 48/13 μs in GSM corresponding to a single path length of approx. 554 m.

Determining the position of a mobile communications device in a UMTS (=Universal Mobile Telecommunication System) network is known from TS 25.305 V3.1.0: stage 2 “Functional Specification of Location Services in UTRAN” (release 99), 3GPP TSG-RAN-WG2, 2000.

In the corresponding UMTS mobile radio standard on which the UMTS network is based, determining the position of a mobile radio device is already explicitly included in the standard or is required by it (TS 25.305 V3.1.0: stage 2 “Functional Specification of Location Services in UTRAN” (release 99), 3GPP TSG-RAN-WG2, 2000).

Further methods for localization of a mobile communications device in a communications network are known from U.S. Pat. No. 5,883,598; U.S. Pat. No. 6,094,168; U.S. Pat. No. 6,108,553.

A non-linear filter, a Prior Density Splitting Mixture Estimator (PDSME) is known from Rauh Andreas, “Nonlinear Measurement Update And Prediction: PRIOR DENSITY SPLITTING MIXTURE ESTIMATOR”, submitted to IEEE Transactions on Automatic Control, December 2002.

This non-linear filter, this PDSME, is based on new Gaussian mix filter algorithms for non-linear system state equations and/or non-linear measurement equations.

Usually linearization errors occur if non-linear system state equations and/or non-linear measurement equations are replaced by linearizations during the use of linear filter techniques.

The PDSME reduces these linearization errors by splitting the a-priori densities into a number of Gaussian mix components each with smaller covariances.

The PDSME can be applied both what is known as a “Prediction Step” for the non-linear systems state equations and also for what is known as a “filter step” for the non-linear measurement equations.

Furthermore a measurement is known for the linearization error from Rauh Andreas which is comparable with a Kullback-Leibler distance. In addition a desired estimation quality can be set for the PDSME. By limiting the maximum number all mix components for the PDMSE an upper limit can be specified for the computing effort.

The localization methods mentioned have the disadvantages that the positions of the mobile communications devices determined by them are inexact and consequently affected by large uncertainties. More precise methods however require expensive additional devices and costly modifications to the communications network or networks and communications devices.

### SUMMARY OF THE INVENTION

An object of the invention is thus to make possible a localization of a mobile communications device in a communications network which is accurate and is affected by the fewest possible uncertainties, which can be implemented as simply as possible and at low cost.

With the method for determining a selected position of a mobile communications device in a communications network with at least one first base station set up for a first communication with the mobile communications device by first communications signals, a non-linear communications model with a deterministic component and stochastic component is used.

The non-linear communications model includes a deterministic and a stochastic component,
the deterministic component of which describes a dependency between communications signals of a base station and positions of the mobile communications device and
the stochastic component of which describes the uncertainty of the deterministic component.

By using the first communications signal belonging to the selected position of the first base station and the non—linear communications model, the selected position is determined, with a non-linear Bayesian filter technique being applied to determine the position.

By applying the non-linear Bayesian filter technique to the communications model or to the communications signal, a possible location area of the selected position is determined from which the selected position is finally determined.

The non-linear Bayesian filter technique in the invention is generally taken to mean the technique described below:
The Bayesian filter technique corresponds to a continuation or modification over time (also computing the change over time) of known probability distributions of the system states and system outputs by the presence of new measured values.

The inventive localization method is based on the idea of obtaining from communications signals between at least one base station (transmitter) and one mobile station (receiver) available in communications networks such as for example WLAN, GSM, DECT networks, distance-relevant parameters and from these geographical information, in this case a possible location or distance area or area of uncertainty of the mobile station.

It should be noted that technologically the transmitter and receiver of the communications signals can also be implemented the other way round. The inventive mode of operation is not affected by this. In this case the base station would be the receiver and the mobile station the transmitter of the communications signals discussed.

The inventive localization method is a further based on the knowledge that the communications signals received by the mobile station are dependent on the geographical position of the mobile station in the communications network or in relation to the base station.

This dependency between at the received communications signals or between a signal strength of the communications signals received (by the base station) and the geographical position of the mobile station can be described by what are referred to as measurement equations, i.e. by the communications model.

These measurement equations or the communications model include a deterministic component describing a dependency between the received communications signal and the position of the mobile station, and a stochastic component describing an uncertainty of the deterministic component.

This uncertainty can for example relate to the communications signal and/or to the dependency mentioned (model uncertainty).

The non-linear Bayesian filter technique applied in accordance with the invention to these measurement equations or the communications model for determining the possible location area of the mobile station or the selected position significantly improves the quality of the localization compared to usual filter techniques such as an Extended Kalmann Filter (EKF).

The non-linear Bayesian filter technique can be undertaken once or iteratively a number of times in a “filter step”.

In this possible location area or area of uncertainty, described using stochastic variables, such as a mean and/or a variance, the mobile station or its position is finally presumed.

The presumption can be formulated mathematically by a characteristic value of the possible location area or area of uncertainty such as a focal point or an expected value. This can then be used as an estimation for the selected position of the mobile station.

A particular advantage of the invention lies in the fact that the localization is conducted on the basis of communications signals and known positions of base stations which occur in a normal operation of a mobile radio system and are available there. This enables expensive modifications and expansions as well as additional measurements of existing mobile radio systems or for existing mobile radio systems to be dispensed with.

The developments described below relate to both the method and to the configuration.

The invention and the developments described below can be implemented both in software and also in hardware, for example by using a specific electrical circuit.

Further the realization of the invention or of a development described below is possible through a computer-readable storage medium on which a computer program is stored which executes according to the invention or development.

For communication in a communications network between a mobile communications device (mobile station), for example a mobile telephone and a base station, for example a circular antenna or a circular radiator or one or more sectoral antennas, data, the communications signals, is transmitted in signal packets known as bursts.

Based on or using at the transmitted communications signals or signal packets various parameters relevant to distance can be determined which in their turn can be included as a basis for determining the possible location areas or distance areas.

Such a distance-relevant, i.e. distance-dependent parameter is for example a field strength of a signal packet.

The field strength exhibits a natural dependency on the distance between the mobile station and the base station (controlling a call) and consequently delivers information about the possible location area or distance area (area of uncertainty) of the mobile station.

This dependency between field strength and distance can be described by physical models which describe a propagation behavior of signals.

For the determination of the selected position a characteristic value of the possible location area or area of uncertainty can be determined, such as a focal point or an expected value which is then used as an estimation for the selected position of the mobile station.

The quality of the localization can be further improved by using a user model which describes a movement of the mobile communications device. Thus such a user model can limit the maximum step length or movement distance for a prespecified time step.

The invention is especially suitable for use in at the environment of a digital cellular mobile radio system such as a GSM network, and there for example for localization of a GSM telephone (mobile telephone).

In this case when the invention is used only the data available to a mobile telephone will be used, in which case costly changes to not have to be made either to the GSM network or to the mobile stations in the GSM network.

For example the positions of the individual base stations and their antennas as well as their characteristics which provide information about the coverage area of the relevant antenna are known from a GSM network.

The mobile telephone for its part always stays in contact with the antennas that can be received for a correct connection set-up so that it can be assigned by the network the antenna which is most suited for a call. To this end it measures the field strengths of the receivable antennas as well as specific signal delay times which are then also known.

On the basis of this available information the mobile telephone is then localized in accordance with the inventive method of operation.

The invention is also suitable for use in the environment of other digital cellular mobile radio systems such as a WLAN or of a DECT network (11], and there for example for localization of a DECT mobile telephone.

### BRIEF DESCRIPTION OF THE DRAWINGS

These and other objects and advantages of the present invention will become more apparent and more readily appreciated from the following description of an exemplary embodiment, taken in conjunction with the accompanying drawings. The exemplary embodiment is in this case subdivided into a basic part which presents the fundamentals of the inventive method of operation and a related part which clarifies or specifies on the basis of a concrete numerical example the inventive method of operation as well as the results. In the Figures,

FIG. 1 is a graph in which it an assumed linear approximation for the non—linear communications model is presented;

FIG. 2 is a graph in which the uncertainty of the communications signal through noise is presented;

FIG. 3 is a block diagram providing an overview of the PDSME algorithm with a linearized filter step (upper section) and a prediction step (lower section);

FIGS. 4A and 4B are graphical representations of an evaluation scenario for localization in accordance with the exemplary embodiment;

FIGS. 5A and 5B are graphs in which a localization using an extended Kalman filter is shown (first filter step FIG. 5a; 170th filter step Fig the. 5b);

FIGS. 6A and 6B are graphs in which a localization using the PDSME in accordance with the exemplary embodiment is shown (first filter step FIG. 6a; 170th filter step, FIG. 6b;

FIGS. 7A and 7B are graphs in which results of the EKF filtering and the PDSME filtering in accordance with the exemplary embodiment in relation to the correct results are shown;

FIG. 8 is a graph in which a number of Gaussian mix components which depend on filter steps are shown.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Exemplary Embodiment Localization of a DECT Mobile Telephone in a DECT Network Based on a Non-Linear Filter Technique

Basics

The application of a non-linear Bayesian filter technique in the localization of a mobile radio telephone is described below. The application is described using as an example a localization of a DECT mobile telephone in a DECT network with a number of base stations.

Signal strengths (as field strengths of the communications signals received by a mobile telephone and measured there (of a base station transmitting the signals) are dependent on the position of the mobile telephone in relation to the base station sending out the communications signals. This relationship is described through non-linear measurement equations (non-linear communications model).

These non-linear measurement equations or this non-linear communications model includes a deterministic component which describes the signal strengths received as a function of the position and a stochastic component which takes account of model errors and measurement noise.

In addition user models are also considered which bring with them knowledge about a (spatial) movement of users of the mobile telephones.

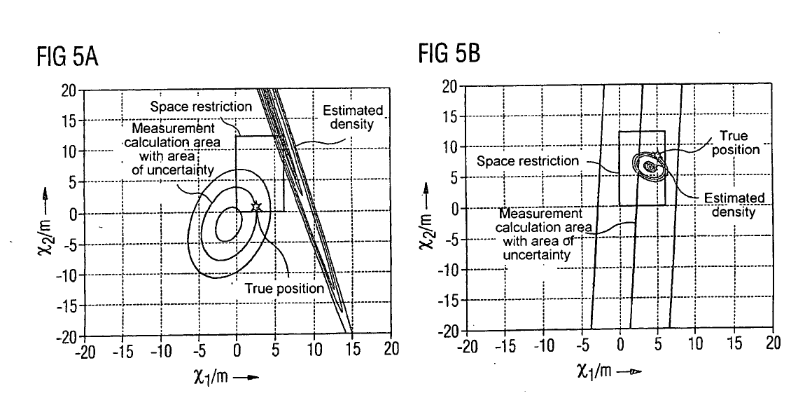

A new non-linear filter technique, known as a “Prior Density Splitting Mixture Estimator” (PDSME), assignable as a Gaussian mix filter algorithm significantly improves a localization quality compared to standard filter techniques such as an “Extended Kalman Filter” (EKF) (cf. FIGS. 5 to 7).

Typical applications for localization tasks are determining the positions of mobile communications devices in WLANs, GSM networks or DECT networks.

For position determination information should be able to be used in such cases which is already available during of a normal operation phase, i.e. for “normal” communication between mobile device and base station.

The localization method known from T. Roos, P. Myllymäki, and H. Tirri, “A Statistical Modeling Approach to Location Estimation”, IEEE Transactions on Mobile Computing 1, pp. 59-69, January-March 2002 for mobile telephones in GSM networks is based on location-dependent signal strengths of the communications signals sent out by base stations, able to be received and measured by the mobile telephones. Because of the location dependency these are characteristic for the position of the signal recipient, in this case for the position of the mobile telephone or of a user of the mobile telephone

During the normal operation phase the received signal strengths of all receivable communications signals of the relevant transmitter (base stations) are measured and compared by the mobile telephone. This is how a handover of the mobile telephone between different transmitters or base stations is controlled.

Based on these measurements made during normal operation localization methods can be developed in order to additionally determine the position of the mobile telephone in relation to the transmitter or in the GSM network.

Further procedures are known from A. M. Ladd, K. E. Bekris, G. Marceau, A. Rudys, D. S. Wallach, and L. E. Kavraki, “Using Wireless Ethernet for Localization”, in Proceedings of the 2002 IEEE/RSN Intl. Conference on Intelligent Robots and Systems, pp. 402-408, EPFL, (Lausanne, Switzerland), October 2002 and S. Panzieri, F. Pascucci, and G. Ulivi, “An Outdoor Navigation system Using GPS and Inertial Platform”, IEEE/ASME Transaction on Mechatronics 7, pp. 134-142, June 2002 for localization of mobile communications devices. These procedures for localization are based on an application of non-linear status estimations.

The application of a new non-linear filter technique for the localization of DECT mobile telephones will be described below.

To make it possible to localize mobile telephones, as is known from B. H. Fleury and P. E. Leuthol, “Radiowave Propagation in Mobile Communications: An Overview of European Research,” IEEE Communication Magazine 23(2), pp. 70-81, 1996, a stochastic approximation model for the propagation of radio waves or receivable signal strengths of communications signals in a localization environment is identified or developed.

A corresponding propagation model can also basically be obtained through physical propagation models of electromagnetic waves.

An adaptation of purely physical propagation models to real (localization) environments is however very complicated since reflections or interference or other physical phenomena influence and falsify the assumed physical propagation.

Since real propagation parameters which describes the electromagnetic (propagation) characteristics in the real localization environment in which the mobile telephone is to be localized are only partly known or determinable the use of such physically-based propagation models for such real applications is excluded.

Therefore a propagation model which is based on actual measurements of the (logarithmized) received signal strengths of the communications signals in the actual localization environment or which can be derived from it is to be preferred over theoretical physical propagation models.

The development of such a measurement model or communications or propagation model derived from actual measurements requires a calibration within the framework of which parameters of the measurement model are defined.

Calibration (“Model Generation Phase”)

For such a calibration the receiver (used in the sense of a measurement device) i.e. the mobile telephone, is moved to a number of positions within the localization environment, for example at grid points obtainable by placing a grid over the localization environment.

At each grid point the field strengths of all base stations which can be received at this point are measured and stored in a map of the localization environment. In this way the field strength distribution of each base station over the localization environment is determined. The field strength distributions can be modeled by the measurement model.

Based on this model information (and on field strengths measured at an actual position) the actual position assumed by a receiver or by the mobile telephone in the localization environment can then be determined (localization in a localization phase).

Furthermore a description is given below of how a stochastic measurement model can be identified in the model generation phase.

This stochastic measurement model is an analytical, deterministic measurement function which describes the logarithmized received signal field strength as a function of position co-ordinates. In addition a stochastic component is identified which takes account of model uncertainty and also measurement noise.

Such a stochastic approach to the localization takes account of the uncertainties in the position determined through probabilities or probability density functions.

As well as the measurement model for the receivable communications signals the quality of the localization is further improved by the fact that a user model is included as well. Via this user model knowledge about a (spatial and/or temporal) movement of a user can be incorporated.

Through such user models maximum “step lengths” of users in a time step which is defined via two associated or corresponding signal measurements (at the start and at the end of the times step) can be restricted.

An additional improvement of the localization quality can be achieved by recursive position determination through a combination of multiple different consecutive measurements.

The new stochastic approach used here for localization results in non-linear multi-dimensional measurement equations. An exact solution of the Bayesian filter problem needs to complicated non-Gaussian probability densities which describe the position sought along with its uncertainties.

These probability density (functions) can be approximated by Gaussian mix densities K. Ito and K. Xiong, “Gaussian filter for Nonlinear filter Problems,” IEEE Transactions on Automatic Control 45, pp. 910-927, May 2000; D. Alspace and H. Sorenson, “Nonlinear Bayesian estimation using Gaussian sum approximations,” IEEE Transactions on Automatic Control 17, pp. 439448, 1972.

This approximation is undertaken here by a newly developed “Prior Density Splitting Mixture Estimator” (PDSME) which has been developed to make it possible for the user to set the quality of the localization—by contrast with usual, non-linear, known filter techniques such as an Extended Kalman filter (EKF).

However specifying an upper limit for a computation effort by restricting the number of Gaussian mix components cannot reduce the localization quality. In addition, by the representation of densities in the Gaussian mixtures a recursive method of operation both for the non-linear predictions steps and also for a non-linear filter steps is possible.

Furthermore the first part describes how the stochastic localization problem can be formulated. The deterministic components and the stochastic components of the measurement model will be explained below. The use of Bayesian filter algorithms based on a Gaussian mix approximation for the exact probability densities used in the new PDSME will be described.

In the second part results of a localization of a DECT mobile telephone in a DECT network will be presented and the quality of the localization using the PDMSE will be compared to that using a known EKF.

Formulating the Localization Problem

The localization task for a mobile communications device in a communications network can be divided up into two basic problems:
1) the identification of the measurement model with a deterministic and a stochastic component in the model generation phase;
2) the determination of the probability density of the position sought in a Bayesian filter step in the localization phase.

The measurement model

$${\underline{\hat{Y}}}_{k} = [ \begin{matrix}\hat{Y} k , 1 \\ ⋮ \\ \hat{Y} k , N\end{matrix} ] = [ \begin{matrix}{h}_{1} ( {\underline{x}}_{k} ) \\ ⋮ \\ {h}_{N} ( {\underline{x}}_{k} )\end{matrix} ] + [ \begin{matrix}{v}_{1} \\ ⋮ \\ {v}_{N}\end{matrix} ] = \underline{h} ( {\underline{x}}_{k} ) + {\underline{v}}_{k} \qquad ( 1 )$$

describes the measurement of the logarithmized received signal strengths

$$\hat{Y} k , ζ = 10 \cdot {log}_{10} ( \frac{{P}_{k , ζ}}{1 m W} )$$

of the ζth transmitter, ζ=1, . . . , N, as a deterministic non-linear function h ζ (xk) of the position coordinates xk=[xl, k, x2, k] for each of the N different transmitters.

The stochastic component vk of the measurement model is represented by an additive uncertainty. Additive uncertainties in the measurement model of the logarithmized receive signal strengths correspond to multiplicative uncertainties of the noise signal power P which are to be attributed to an influence of unspecified attenuations.

Each transmitter can be identified by its own ID which is transmitted by the base station during a communication.

This makes the localization problem considerably simpler since each measured value can be directly assigned to the appropriate non linear measurement equation.

In the localization phase the non-linear filter algorithms will be applied in each time step k. However without the additive uncertainties vk the implicit, non-linear relationships between the vector with the measured logarithmized received signal strengths yk of the transmitter can only be resolved numerically for example by a recursive least squares method. If the uncertainties are also taken into account the measurement equations can be used to update the position sought in the filter step.

The further described method of operation for the localization is based on an approximation of the exact solution of the Bayesian filter step by Gaussian mixture densities

$${f}_{x}^{p} ( {\underline{x}}_{k} ) = {\sum }_{i = 1}^{L} {ω}_{x , k}^{p , i} \frac{exp ( - \frac{1}{2} {‖ {\underline{x}}_{k} - {\underline{μ}}_{x , k}^{p , i} ‖}_{{( {c}_{xx , k}^{p , i} )}^{- 1}}^{2} )}{\sqrt{{( 2 π )}^{2} \vert {C}_{xx , k}^{p , i} \vert}}$$

with L components, defined by non-negative weights or expected values p and covariances C.

If the measured value y is available the exact solution of the Bayesian filter step is produced:
fₓ^{e}(xₖ|Ŷk,ζ)=cfₓ^{P}(xₖ)fv,ζ(Ŷk,ζ−hζ(xₖ))

with the non-linear measurement function h(x), the additive uncertainty density functions f (v) and a normalization constant C.

A-priori knowledge about the position sought is represented by the density function f(x).

For each new measurement the previous a-posteriori density f(x|y) is interpreted as a new a-priori density so that the position sought or determined can be recursively updated.

Similarly to the Bayesian filter step a prediction step which is used to describe the non-linear user model
xₖ₊₁=aₖ(xₖ)+wₖ (2)
is likewise executed for approximation of the exact densities by Gaussian mixtures.

The non-linear function a(x) is a deterministic model of a user movement. Uncertainties are again taken into account by additive noise.

Stochastic Modeling

The measurement model is identified using measurements of the logarithmized signal strengths for each transmitter at grid points of a grid which covers the localization environment. The deterministic (h(x)) and the stochastic component (v) of the measurement model (1) are identified before the localization.

The deterministic, analytical component h(x) is a measurement equation which describes the received signal power as a function of the position coordinates. The stochastic component v is a model for the uncertainty of the deterministic component. These uncertainties are made up of a spatial uncertainties corresponding to model errors and measurement noise over time.

Deterministic Measurement Model of the Logarithmized Received Signal Strengths

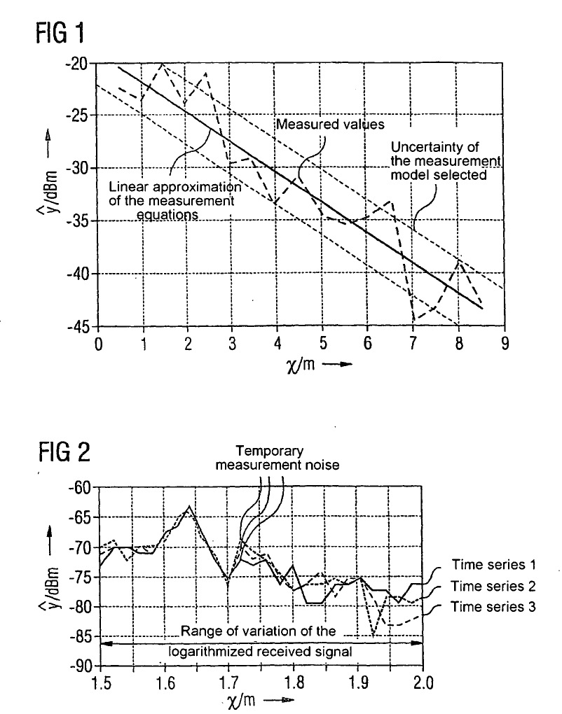

FIG. 1 shows that the acceptance of the logarithmized receive signal strengths over a distance of a number of meters is almost linear. In other documents similar assumptions in relation to the measurement model are referred to as “linear-loss-model” J. Lähteenmäki, “Radiowave Propagation in Office Buildings and Underground Halls”, in Proc. 22nd European Microwave Conference EurMC '92, pp. 377-382 (Espoo, Finland), 1992.or “linear-scope-model B. H. Fleury and P. E. Leuthol, “Radiowave Propagation in Mobile Communications: An Overview of European Research,” IEEE Communication Magazine 23(2), pp. 70-81, 1996.

Mathematically linear acceptance of the logarithmized receive signal strengths for two-dimensional position coordinates x can be described by N independent measurement equations.
h_{ζ}(xₖ)=−\sqrt{∥x}ₖ−m_{ζ}∥_{P}_{_{ζ}}_{^{−1}}²+Δζ (3)

The parameters mζ and Pζ of the positive semi-definite quadratic form and the additive offset Δζ are identified for each transmitter ζ=1, . . . , N.

The 6N parameters mζ, Pζ and ζC are determined by a method of recursive least squares in which the deviation between the approximated measurement model and the measured logarithmized signal strengths at the grid points measured during the model generation phase are minimized. To reduce the measurement noise over time the mean value over a number of measurements at each grid point Is used to calculate the average of the measured values.

Stochastic Modeling of the Uncertainties

The stochastic uncertainty model takes account of both the deviation between the approximated model described above and the true distribution of the logarithmized receive signal strengths measured at the grid points and the measurement noise over time.

Model Uncertainties

In this localization approach the deviation between true logarithmic receive signal power and the deterministic measurement model h(xₖ) is described for each transmitter by a Gaussian noise density with a mean value of μ_{u,ζ}⁽¹⁾ and standard deviation σ_{ν,ζ}⁽¹⁾. This Gaussian uncertainty is a representation of the approximation error of the deterministic components of the measurement model over the entire localization environment. It first represents the mean deviation over the localization environment between the model and the true receive power on the basis of the incorrect assumptions for the deterministic part of the measurement equation. The uncertainties produced from large deviations between the true receive signal power and the measurement model are shown in FIG. 1. Secondly measurements have also shown that local deviations exist which could have been caused by reflections, non-homogeneous propagation of the radio waves and interference. These spatial variations of the logarithmic receive signal power can be seen from FIG. 2 in which measurements have been collected at a spacing of 2 cm.

Measurement Noise

In addition to spatial variations of the receipt signal power measurement noise over time can be determined by evaluating a series of several different measurements at a fixed point. This measurement noise over time is also shown in FIG. 2 for three different measurements of the logarithmic receive signal power at each measurement point. This noise is in its turn approximated by a Gaussian density with a mean of μ_{u,ζ}⁽²⁾ and standard deviation σ_{ν,ζ}⁽²⁾.

Combination of Modeling Certainties and Measurement Noise

To obtain a simple model with the two uncertainties described above it is further assumed that the two uncertainties are independent. They can thus be modeled by a single Gaussian density f_{ν,ζ}(u_{ζ}) for each transmitter ζ=1, . . . , N, which is defined by the mean
μ_{ν,ζ}=(σ_{ν,ζ}⁽¹⁾)²+(σ_{ν,ζ}⁽²⁾)²
and the standard deviation
μ_{ν,ζ}=\sqrt{(σ_{ν,ζ}⁽¹⁾)²=}(σ_{ν,ζ}⁽²⁾)²

This model implies not only independent uncertainties but it is also assumed that the two uncertainties can be described without taking into account any positional dependency.

Filter Algorithm

This section gives a brief overview of the PDSME (Prior Density Splitting Mixture Estimator) used for the localization of radio communications devices. In addition an adaptation of the measurement equations derived in Section 3 h(xₖ) is introduced to simplify the computation or the PDSME estimator. Furthermore a prediction step for a simple user model is presented.

The PDSME Measurement Updating

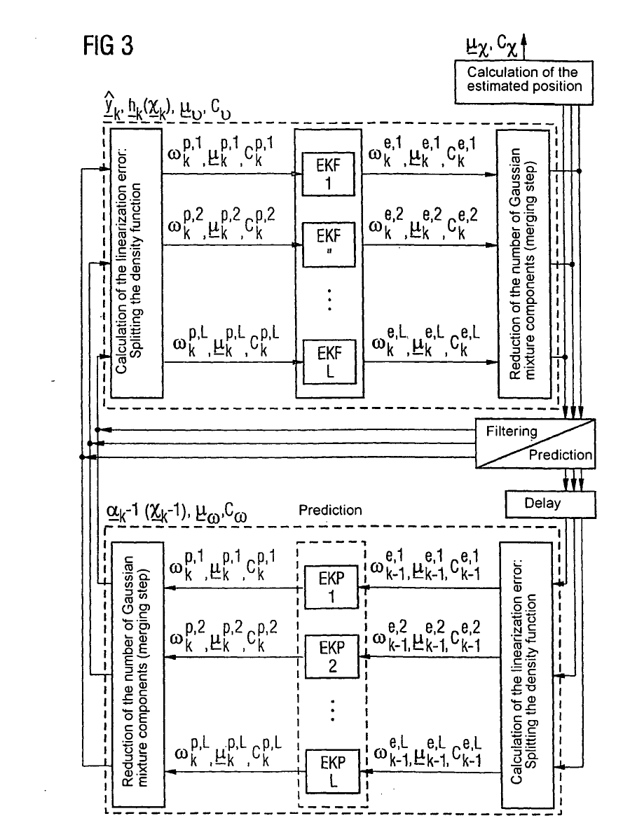

The PDSME algorithm for the localization of radio communications devices shown in this step is based on the calculation of a linearized measurement update for Gaussian mixture densities. The measurement updating step of this filter algorithm is shown in a block diagram in the upper part of FIG. 3. Splitting is based on the calculation of the linearization error

$$D \text{?} ( {\overline{f}}_{w}^{c , i} \vert \vert {f}_{w}^{c , i} ) = {\int }_{{R}^{2}} {\overline{f}}_{x}^{c , i} ( {\underline{x}}_{k} \text{\vert} {\hat{y}}_{k , ζ} ) {( ln ( \frac{{\overline{f}}_{w}^{c , i} ( {x}_{k} \text{\vert} {\hat{y}}_{k , ζ} )}{{f}_{z}^{c , i} ( {\underline{x}}_{k} \text{\vert} {\hat{y}}_{k , ζ} )} ) )}^{2} ⅆ {\underline{x}}_{k} \\ \text{?} \text{indicates text missing or illegible when filed} \qquad ( 4 )$$

for each component of the Gaussian a-posteriori mixture density. This criterion is very similar to the Kullback-Leibler distance S. Kullback and R. A. Leibler, “On information and Sufficiency”, Annals of Mathematical Statistics 22, pp. 79-86, 1951

$$D ( {\overline{f}}_{w}^{c , i} \vert \vert {f}_{w}^{c , i} ) = {\int }_{{R}^{2}} {\overline{f}}_{x}^{c , i} ( {\underline{x}}_{k} \text{\vert} {\hat{y}}_{k , ζ} ) ln ( \frac{{\overline{f}}_{w}^{c , i} ( {x}_{k} \text{\vert} {\hat{y}}_{k , ζ} )}{{f}_{z}^{x , i} ( {\underline{x}}_{k} \text{\vert} {\hat{y}}_{k , ζ} )} ) ⅆ {\underline{x}}_{k}$$

between the exact a-posteriori density

$$f \text{?} ( {\underline{x}}_{k} \text{\vert} {\hat{y}}_{k , ζ} )$$

$$\text{?} \text{indicates text missing or illegible when filed}$$

and its approximation (equation) by replacing the non-linear measurement

$$\overline{f} \text{?} ( {\underline{x}}_{k} \text{\vert} {\hat{y}}_{k , ζ} )$$

$$\text{?} \text{indicates text missing or illegible when filed}$$

h(Xₖ) by its linearization

$$\underline{\overline{h}} ( \underline{{x}_{k}} )$$

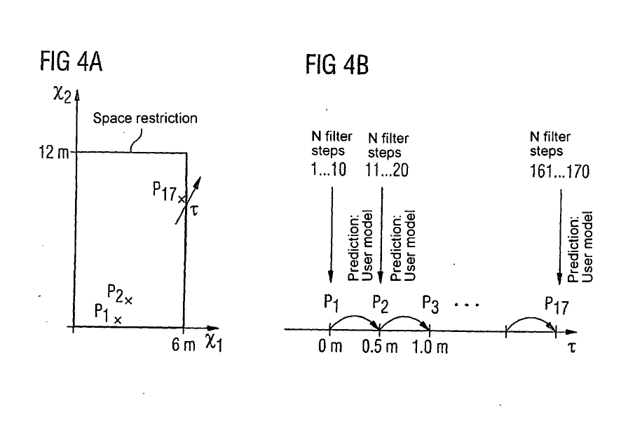

at the mean of the ith component of the a-priori-density function. By calculating the linearization error (4) the Gaussian a-priori mixture components which contribute most to the approximation error of the a-posteriori density are identified. To reduce this linearization error these Gaussian mixture components are replaced by being split up into a number of mixture components with smaller covariances using splitting libraries which have been optimized offline (see FIG. 4).

After this “analytical resampling” of the a-priori densities, the filter step can be calculated by a bank of EKF, linearization of the measurement equation at the mean of each component of the representation of the Gaussian mixture of the a-priori density.

Thereafter redundancy is reduced by a merging step by combining a number of Gaussian mixture components into a single Gaussian with negligible approximation error.

Adaptation of the measurement model for simplifying the linearization error criterion

For Gaussian measurement noise the linearization error (4) can be calculated analytically as a linear combination of moments of the densities

$$\overline{f} \text{?} ( {\underline{x}}_{k} \text{\vert} {\hat{y}}_{k , ζ} )$$

$$\text{?} \text{indicates text missing or illegible when filed}$$

for polynomial measurement equations hζ(Xₖ). In this subsection an adaptation of measurement equation (3) is thus derived. After a few algebraic transformations the quadratic measurement equation

$$\underbrace{{( {\hat{y}}_{k , ζ} - {Δ }_{ζ} )}^{2}}_{\text{?}} = {‖ {\underline{x}}_{k} - {\underline{m}}_{ζ} ‖}_{{P}_{ζ}^{- 1}}^{2} + \underbrace{( 2 ( {\hat{y}}_{k , ζ} - {Δ}_{ζ} ) {v}_{ζ} - {v}_{ζ}^{2} )}_{\text{?}} \\ \text{?} \text{indicates text missing or illegible when filed} \qquad ( 5 )$$

can be rewritten with a polynomial function with a modified “measured value” \check{Z}_{k,ζ} and the transformed uncertainty \check{U}_{ζ}. Because of the non-linear transformation of the random variable u_{ζ} the probability density function

$${f}_{υ , ζ} ( {\overline{υ}}_{ζ} )$$

is no longer Gaussian. In the localization experiment in Section 5 the exact moments of first and second order \check{U}_{ζ} will be calculated to determine a Gaussian approximation of

$${f}_{υ , ζ} ( {\tilde{υ}}_{ζ} )$$

It should be noted that the moments \check{U}_{ζ} depend on the measured value \check{y}_{k,ζ}. They must thus be recalculated for each new measurement of the logarithmic receive signal power and are not unchangeable over time like the parameters described in Section 3μ_{u,ζ} and σ_{u,ζ.}

User Modeling by PDSME Prediction Step

Like the filter step the PDSME can also be applied to the calculation of non-linear prediction steps. In a similar way to non-linear filter steps the calculation of an approximated prediction step also includes an evaluation of a linearization error, a bank of linearized prediction steps and the reduction of the number of Gaussian mixture components in a merging step (see lower part of FIG. 3). In this work only a linear user model is taken into consideration. The predictions step can thus be calculated analytically since a-posteriori density has been approximated by Gaussian mixture density in the filter step.

The prediction model uses the linear status equation

$${\underline{x}}_{k + 1} = {\underline{x}}_{k} + {\underline{w}}_{k} ,$$

with the mean μ_{ω} of the additive system noise ωₖ representing knowledge about possible directions and average step lengths of the movement of the user. The covariance matrix C_{ω} of ωₖ specifies an estimation for the distribution of the step lengths of the user. For each component i=1, . . . , L of the Gaussian mixture density the predicted Gaussian mixture component is then described by the mean

$${\underline{μ}}_{k + 1}^{i} = {\underline{μ}}_{k}^{i} + {μ}_{w}$$

and the covariance

$${C}_{k + 1}^{i} = {C}_{k}^{i} + {C}_{w} .$$

The estimated position can then be calculated as weighted overlaying

$$\frac{{\sum }_{i = 1}^{L} {w}_{k + 1}^{i} {\underline{μ}}_{k + 1}^{i}}{{\sum }_{i = 1}^{L} {w}_{k + 1}^{i}}$$

of the mean values of all Gaussian mixture components.
Localization Experiment

In this section a real localization experiment for the validation of the localization approach described is presented for DECT mobile telephones. In these subsections the superior performance of the PDSME by comparison with the EKF (Extended Kalman Filter), a widely-used standard approach for estimating the status of non-linear systems, is shown.

Evaluation Scenario

In this localization experiment N=10 transmitters have been placed in an internal space of approximately 30 m×30 m on a floor of a building. In the model generation phase the logarithmic receive signal part of each transmitter has been measured on a grid with 1 m spacing between grid points. IN=10 measurement equations h_{ζ(x}ₖ), consisting in total of 60 parameters for the deterministic components and 20 parameters for the stochastic components μₖ have been identified. Apart from just a few areas which were influenced by the high attenuation of the radio waves as a result of steel and concrete walls, the assumed model is an appropriate approximation of the distribution of the receive signal power.

The initial probability density of the position is selected as a Gaussian density with the initial mean value

$${\underline{μ}}_{0}^{p} = [ \begin{matrix}15 m \\ 15 m\end{matrix} ]$$

and initial covariance

$${C}_{D}^{p} = [ \begin{matrix}{15}^{2} & 0 \\ 0 & {15}^{2}\end{matrix} ] {m}^{2} ,$$

i.e. there is almost no prior knowledge available about the position.

In the localization phase a measurement of each receivable transmitter is collected along a line, as shown in FIG. 4, with a spacing of Δr=0,5 m between the true measurement points P₁, P₂, P₁₇. The position co-ordinates of the measurements have been determined to compare the basic actuality with the estimated positions. For the localization of the receiver the exact measurement positions have not been used either in the localization approach with the PDSME or with the EKF. After the measurement update for each receivable transmitter at a fixed point Pᵢ, i=1, . . . , 17 has been calculated, a prediction step in accordance with Subsection 4.3 has been calculated. In the present example the simple user model is defined by the mean
μ_{ω}=0m
and the covariance

$${C}_{w} = [ \begin{matrix}1 & 0 \\ 0 & 1\end{matrix} ] {m}^{2} ,$$

i.e. there is no knowledge available about a preferred direction of the movement of the user. The covariance matrix C_{ω} only represents the distribution of the step lengths of the user.

EKF Filter (Extended Kalman Filter)

When the EKF filter is used the measurement equation (5) is linearized at the mean of the a-priori density function. FIG. 5 shows the results of the EKF for the first and the 170th filter step. For each filter step the measurement of the logarithmic receive signal power of a single transmitter is used for updating the estimated position.

It can be seen that after the first filter step there is a significant estimation error. The true position of the receiver does not lie within the support values of the estimated a-posteriori density function, which is shown by the profile representation. Furthermore there is no crossing point between the true measurement equation and the estimated density. It is thus not possible to apply data validation processes to establish whether a measured value can be “explained” by the estimated density.

PDSME (Prior Density Splitting Mixture Estimator)

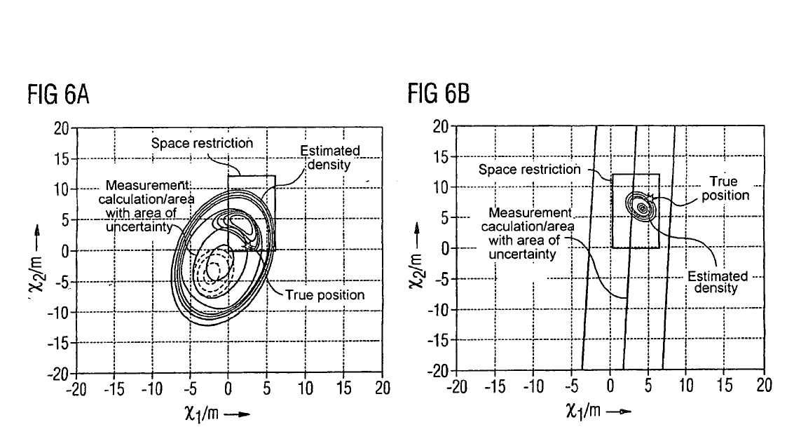

FIG. 6 shows the a-posteriori densities for the first and 170th filter steps estimated by the PDSME algorithm. The approximation of the non-Gaussian a-posteriori density in the first filter step which lies very close to the numerically calculated optimum Bayesian solution of the filter step is clearly much better than in the case of the EKF filter. Data validation procedures can thus be successfully applied.

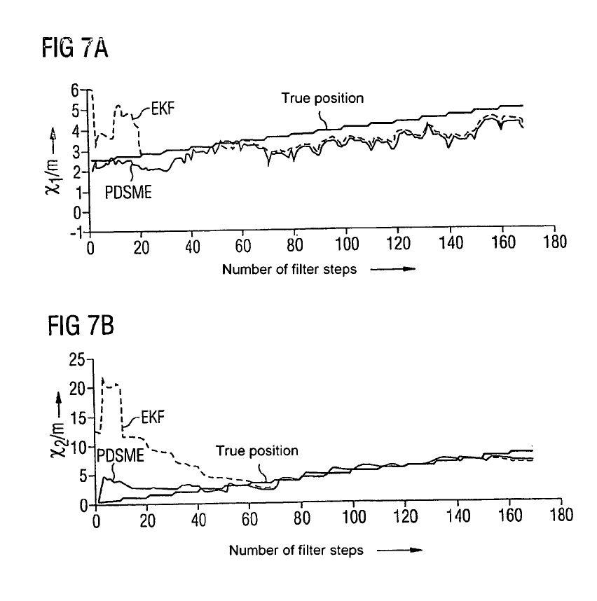

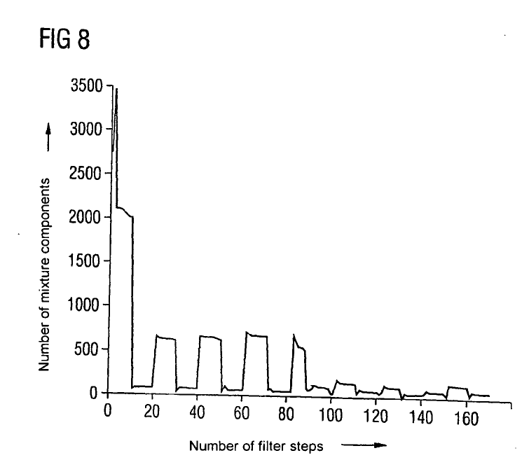

In FIG. 7 the expected values of the a-posteriori density functions calculated with the EKF and the PDSME are compared to the true position. If this figure is compared with FIG. 8 it can be seen that for almost linear filter problems, i.e. if the covariance of the estimated position by comparison with the non-linearity of the measurement equation after a number of filter steps is small, EKF and PDSME yield almost the same results. In these cases the PDSME uses only a modest number of Gaussian mixture components whereas for strong non-linearities at the beginning of the localization experiment a higher number of approximation components is necessary to reduce the estimation error. The superior power of the PDSME filter by comparison with the EKF is also shown by the average estimation error

$$\frac{1}{{N}_{F}} {\sum }_{k = 1}^{{N}_{F}} \sqrt{{‖ {\underline{x}}_{k}^{true} - {\underline{x}}_{k}^{estimated} ‖}_{2}^{2}}$$

over the N_{F}=170 filter steps which amount to 3,30 m for the EKF and 1,22 m for the PDSME.

### CONCLUSIONS

In this work a stochastic approach to a localization of radio communications devices has been offered to which is based on the measurement of the logarithmic signal power of the receivable transmitters by a mobile station. For each transmitter a stochastic measurement model has been identified which consists of a deterministic and a stochastic component. This measurement model has been used for the estimation of the position of the receiver through an innovative Gaussian mixture estimator which is based on the splitting of the a-priori density corresponding to a linearization error criterion. This criterion is very similar to the Kullback-Leibler distance between the true and the approximated a-posteriori density which is calculated by a linearization of the measurement equation. By applying this estimation procedure to the localization of DECT mobile telephones significant improvements to the estimation quality can be achieved if the PDSME is used instead of the standard approaches such as the EKF. Further improvements to the localization quality by identifying better deterministic measurement models and more exact identification of the measurement noise can be achieved which do not assume any independence between the different uncertainties mentioned in this work.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-20. (canceled)

21. A method for determining a selected position of a mobile communications device in a communications network having at least one base station, comprising:
determining a possible location area of the mobile communications device by applying a non-linear Bayesian filter technique in which a non-Gaussian probability density is approximated by Gaussian mixture densities; and
determining a selected position of the mobile communications device within the possible location area using a first communications signal of a first base station associated with the possible location area and using a non-linear communications model with a deterministic component and a stochastic component, the deterministic component describing a dependency between communications signals of the first base station and positions of the mobile communications device and the stochastic component describing an uncertainty of the deterministic component.

22. A method in accordance with claim 21,
wherein said at least one base station includes a second base station, set up for a second communication with the mobile communications device by a second communications signal, and
wherein said determining of the selected position uses at least one of the first communications signal and the second communications signal together with the non-linear communications model.

23. A method in accordance with claim 22, wherein said determining of the possible location area includes determining at least one distance-dependent parameter depending on a distance between the mobile communications device and at least one of the first and second base stations using at least one of the first and second communications signals.

24. A method in accordance with claim 23, wherein the uncertainty of the deterministic component includes at least one of uncertainty of the communications signals caused by measurement noise and uncertainty of the non-linear communications model.

25. A method in accordance with claim 24, wherein the first communications signal is at least one of time-dependent and measured for a point in time k.

26. A method in accordance with claim 25, wherein the non-linear Bayesian filter technique is applied iteratively.

27. A method in accordance with claim 26, wherein one of a Gaussian mixed filter algorithm and an extended Kalman filter is used in the non-linear Bayesian filter technique.

28. A method in accordance with claim 27, wherein the Gaussian mixed filter algorithm is a Prior Density Splitting Mixture Estimator.

29. A method in accordance with claim 28, wherein said determining of the selected position further uses a user model describing a movement of the mobile communications device.

30. A method in accordance with claim 29, wherein in the user model, the movement of the mobile communications device is limited for a time step.

31. A method in accordance with claim 30, wherein said determining of the selected position determines an estimated position for the selected position using the user model.

32. A method in accordance with claim 31, wherein the estimated position is determined by applying the non-linear Bayesian filter technique.

33. A method in accordance with claim 32, wherein the estimated position is used as a starting value for said determining of the possible location area of the selected position through the application of the non-linear Bayesian filter technique.

34. A method in accordance with claim 33, wherein the communications network is a WLAN, GSM or DECT network.

35. A method in accordance with claim 34, wherein one of a focal point and an expected value of the possible location area is used as the selected position of the mobile communications device.

36. A method in accordance with claim 35,
wherein the mobile communications device is a mobile telephone in a digital cellular mobile radio network and the first base station is a call-controlling base station in the digital cellular mobile radio network, and
wherein said determining of the selected position enables localization of the mobile telephone.

37. A configuration for determining a selected position of a mobile communications device in a communications network having at least one base station, comprising:
a position-determining unit determining a possible location area of the mobile communications device by applying a non-linear Bayesian filter technique in which a non-Gaussian probability density is approximated by Gaussian mixture densities and determining a selected position of the mobile communications device within the possible location area using a first communications signal of a first base station associated with the possible location area and using a non-linear communications model with a deterministic component and a stochastic component, the deterministic component describing a dependency between communications signals of the first base station and positions of the mobile communications device and the stochastic component describing an uncertainty of the deterministic component.

38. At least one computer readable medium storing instructions that when executed control a computer to perform a method for determining a selected position of a mobile communications device in a communications network having at least one base station, comprising:
determining a possible location area of the mobile communications device by applying a non-linear Bayesian filter technique in which a non-Gaussian probability density is approximated by Gaussian mixture densities; and
determining a selected position of the mobile communications device within the possible location area using a first communications signal of a first base station associated with the possible location area and using a non-linear communications model with a deterministic component and a stochastic component, the deterministic component describing a dependency between communications signals of the first base station and positions of the mobile communications device and the stochastic component describing an uncertainty of the deterministic component.
